(19) United States
(12) Patent Application Publication
(10) Pub. No.: US 2013/0060445 A1
(43) Pub. Date: Mar. 7, 2013

(54) USE OF AN ESTIMATED VOLUMETRIC EFFICIENCY FACTOR FOR ERROR MONITORING IN THE AIR SYSTEM

(71) Applicants: Thomas BLEILE, Stuttgart (DE); Stefan Michael, Markgroeningen (DE); Andras Montvay, Markgroeningen (DE); Christina Hoepfner, Bergen (DE); Mark Ringeisen, Gaeufelden (DE)

(72) Inventors: Thomas BLEILE, Stuttgart (DE); Stefan Michael, Markgroeningen (DE); Andras Montvay, Markgroeningen (DE); Christina Hoepfner, Bergen (DE); Mark Ringeisen, Gaeufelden (DE)

(21) Appl. No.: 13/598,399

(22) Filed: Aug. 29, 2012

(30) Foreign Application Priority Data
Sep. 1, 2011 (DE) 10 2011 081 959.2

(51) Int. Cl. G06F 17/00

(52) U.S. Cl. 701/101; 701/99

(57) ABSTRACT

A device for error monitoring in an internal combustion engine system is provided. The internal combustion engine is supplied with air at a volumetric efficiency indicating the ratio of a real volume flow of air in the internal combustion engine to an ideal, theoretically possible, volume flow of air in the internal combustion engine. The device for error monitoring is configured to determine an error in the engine system when a difference between a measured volumetric efficiency and an estimated volumetric efficiency exceeds a predetermined absolute value.

### BACKGROUND OF THE INVENTION

1. Field of the Invention

The present invention relates to an on board diagnostic system in a vehicle having an internal combustion engine.

2. Description of the Related Art

On board diagnostic systems are vehicle diagnostic systems which monitor all emission-influencing systems during the operation and store possibly arising errors in a memory so that they may be queried by a specialized repair shop and, if necessary, eliminated.

Most of the previously known functions in this type of on board diagnostic system measure a characteristic within the internal combustion engine at operating points, which occur rarely in most cases, and compare this characteristic to the nominal case. Alternatively, a so-called intrusive test may be carried out. This test is an intervention into the system at certain operating points to provide the conditions for the measurement. In any case, the situation in the nominal case must be saved so that the measurement may be compared to it. However, a memory is not only expensive, it also needs space which is available only to a limited extent in the engine control of a vehicle.

### BRIEF SUMMARY OF THE INVENTION

According to one first aspect of the present invention, a device for error monitoring in an engine system having an internal combustion engine is provided, the engine system being designed to supply the internal combustion engine with air at a volumetric efficiency, the volumetric efficiency indicating the ratio of a real volume flow of air in the internal combustion engine to an ideal, theoretically possible, volume flow of air in the internal combustion engine, the device being designed to determine an error in the engine system based on the volumetric efficiency.

The device according to the present invention has the advantage that it requires less memory space as compared to conventional devices for error monitoring in an engine system. This is achieved by selecting for the characteristic of error recognition the volumetric efficiency as a variable in the engine system, the variable being necessary, e.g., for operating the filling control, regardless of the device for error monitoring. In this way, the data do not have to be specifically determined and stored in the memory for the comparison to the nominal case. The time constant of the volumetric efficiency estimation/recognition is approximately in the range of the time constant of the filling control. In this way, the volumetric efficiency is available relatively quickly compared to previously known systems. This expands the ranges in which monitoring is possible since it is also conceivable to use the volumetric efficiency recognition during relatively short controlled operating modes. The volumetric efficiency is calculated by being compared to a variable which was previously applied for the nominal state (normal vehicle operation). It is thus not necessary to separately apply and save the situation in the nominal case. This reduces the complexity of the application and the storage space required in the control unit.

In one embodiment of the present invention, the device may include the following characteristics:
a measuring device which is suitable to measure the volumetric efficiency;
an estimation device which is suitable to estimate the volumetric efficiency; and
a checking device which is suitable to check the measured volumetric efficiency for plausibility based on the estimated volumetric efficiency.

The estimation device may estimate the volumetric efficiency in particular based on a provided model of the internal combustion engine.

In one preferred embodiment of the present invention, the device is a vehicle diagnostic system for a vehicle driven by the internal combustion engine. Vehicle diagnostic systems, such as on board diagnostic systems, are devices in a vehicle which are required by law and from which the function of the vehicle itself does not benefit at all. They are only used to comply with the regulations for environmental protection. The device according to the present invention may be used to carry out this type of vehicle diagnostic system based on the characteristics which must be calculated anyway for the vehicle to function properly, thus saving resources in the engine control unit.

In another preferred embodiment of the present invention, the checking device for the plausibility check may be provided to calculate a difference between the measured volumetric efficiency and the estimated volumetric efficiency, and to output an error when the difference exceeds a predetermined absolute value. The comparison between the difference and a predetermined absolute value makes it possible to introduce tolerances into the system which allow those deviations from the nominal state to be ignored which do not result in a noteworthy malfunction of the vehicle.

According to another aspect of the present invention, an engine system includes, for driving a vehicle, an internal combustion engine for receiving an intake charge of fresh air for a fuel combustion and for outputting exhaust gas after the fuel combustion, and a device according to the present invention for outputting an error when the plausibility check of the volumetric efficiency factor results in a deviation between the measured and the estimated volumetric efficiency factor. In the engine system according to the present invention, erroneous exhaust gas values may easily be recognized, without having to implement additional measuring systems in the engine system.

In one refinement of the present invention, the engine system includes an intake system for taking in gas into the engine system, an exhaust gas recirculation for recirculating at least a portion of the exhaust gas into the internal combustion engine, and a mixing section for mixing the fresh air and the recirculated exhaust gas for filling. In this way, an exhaust gas recirculation is provided which makes it possible to reduce the portions of discharged harmful agents in the exhaust gas, such as nitrogen oxides.

In another refinement, the device for measuring the volumetric efficiency based on the pressure, the temperature, and the rotational speed may be provided in the internal combustion engine. This makes it possible to measure the volumetric efficiency with the aid of sensors which are already present in the internal combustion engine.

In an alternative or additional embodiment, the device for estimating the volumetric efficiency based on an enthalpy flow balance between the enthalpy flow of the gas taken in and the enthalpy flow of the recirculated exhaust gas may be provided. The enthalpy flow balance may be ascertained in the engine system with the aid of already present sensors so that the boundary conditions for the estimation of the volumetric efficiency are determinable without further technical changes in the engine system.

In another embodiment of the present invention, the device for estimating the enthalpy flow of the recirculated exhaust gas based on a mass flow of the recirculated exhaust gas through the exhaust gas recirculation may be provided. This estimation is, for example, possible in a simple manner based on the measured variables such as the position signal/actuating signal present at the valve in the exhaust gas recirculation.

In an additional embodiment of the present invention, the device for estimating the enthalpy flow of the recirculated exhaust gas based on a mass flow of the recirculated exhaust gas through the mixing section may be provided. This estimation is possible in a simple manner via an enthalpy flow balance between the enthalpy flow of the gas taken in and the enthalpy flow in the internal combustion engine.

In one preferred embodiment of the present invention, the device for selecting the enthalpy flow calculated based on the actuating signal of the exhaust gas recirculation valve or the enthalpy flow modeled based on the enthalpy flow balance at the mixing location may be provided for the estimation of the volumetric efficiency. The signal quality of the volumetric efficiency with regard to the signal noise ratio is always equally good since the volumetric efficiency is calculated by using different sources of information. Here, insensitive ranges or operating modes are suppressed so that a signal of adequate quality is always available. When calculating the characteristics in previously known on board diagnostic systems, these insensitive ranges in which the signal is, for example, strongly affected by noise must be explicitly blended out with the aid of operating range restrictions.

According to another aspect of the present invention, a method for error monitoring in an engine system, which fills a filling of gas into an internal combustion engine at a volumetric efficiency, the volumetric efficiency indicating the ratio of the real volume flow in the engine to the ideal (theoretically possible) volume flow in the engine, includes the following steps: measuring the volumetric efficiency, estimating the volumetric efficiency, and checking the measured volumetric efficiency for plausibility based on the estimated volumetric efficiency.

### BRIEF DESCRIPTION OF THE DRAWINGS

FIG. 1 shows a block diagram of an engine system.

FIG. 2 shows a simplified illustration of the block diagram from FIG. 1.

FIG. 3 shows a block diagram for checking a measured volumetric efficiency based on an estimated volumetric efficiency.

### DETAILED DESCRIPTION OF THE INVENTION

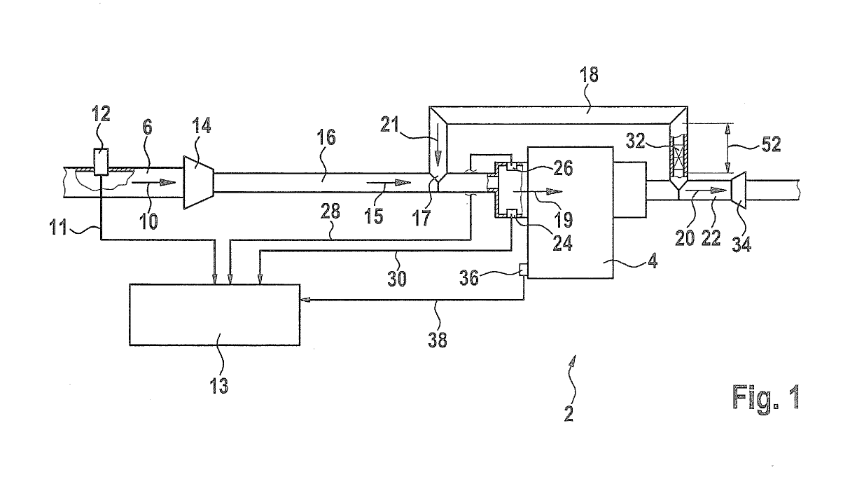

Reference is made to FIG. 1. An engine system 2 having an internal combustion engine 4 is illustrated in FIG. 1.

Fresh air 10 is supplied via an air supply 6 to internal combustion engine 4 initially in the flow direction identified by arrows. An air mass flow measuring device 12, in the form of a hot film air mass flow sensor, for example, which measures fresh air mass flow 11 and outputs it to an engine control 13, is situated in air supply 6. Alternatively, the fresh air supply may also be modeled and the necessary sensor may be modeled at another place in the air system.

Subsequently, symbol \dot{m}_{L} is assigned to fresh air mass flow 11.

Downstream from air mass flow measuring device 12 in the flow direction, one or multiple compressors 14 may be situated in air supply 6. The compressed air is provided with reference numeral 15.

The section of air supply 6 downstream from compressor 14 in the flow direction is referred to in the following as intake manifold 16. Exhaust gas 20 may be supplied to intake manifold 16 in a junction 17 via an exhaust gas recirculation channel 18 from an exhaust gas system 22 of engine system 2. Engine intake air 19 resulting therefrom is supplied to internal combustion engine 4. The flow directions of exhaust gas 20 in exhaust gas system 22 and engine intake air 19 are identified by an arrow. The recirculated exhaust gas is provided with reference numeral 21 whose flow direction is also identified by an arrow. Fuel may be injected into engine intake air 19 or into compressed air 15 as is the case in some gasoline engines, for example. Alternatively, the fuel may also be injected directly into the internal combustion engine as is customary for a diesel engine.

In the flow direction downstream from junction 17 of exhaust gas recirculation channel 18 into intake manifold 16, a pressure sensor 24 and a temperature sensor 26 are situated in intake manifold 16. Temperature sensor 26 and pressure sensor 24 ascertain temperature 28 and pressure 30 of supplied and compressed air 15, which, if necessary, is enriched with recirculated exhaust gas 21, and output them to engine control 13. The pressure and temperature information may also be modeled on the basis of other, placed sensors.

An exhaust gas recirculation valve 32 is situated in exhaust gas recirculation channel 18 to control the quantity of recirculated exhaust gas 21. As previously described, internal combustion engine 4 has on its output side exhaust gas system 22 off of which exhaust gas recirculation channel 18 branches. In the flow direction downstream from the branch-off of exhaust gas recirculation channel 18 situated in exhaust gas system 22, one or multiple turbines 34 may be situated which drive compressor 14, for example. Furthermore, a rotational speed sensor 36, which ascertains rotational speed 38 of internal combustion engine 4 and outputs it to engine control 13, is situated on internal combustion engine 4.

The mass flow of engine intake air 19, which is referred to in the following as the filling is assigned symbol \dot{m}_{F} for subsequent calculations. The filling is yielded from the sum of intake gas mass flow 11 having symbol \dot{m}_{L}, which is, for example, measured using air mass flow measuring device 12, and the mass flow of recirculated exhaust gas 18. In addition to the measurement by air mass flow measuring device 12 in the closed exhaust gas recirculation, filling \dot{m}_{F} may also be calculated as follows:

$${\dot{m}}_{F} = {λ}_{a} \frac{{V}_{H} \cdot n \cdot p}{2 \cdot R \cdot T} \qquad ( 1 )$$

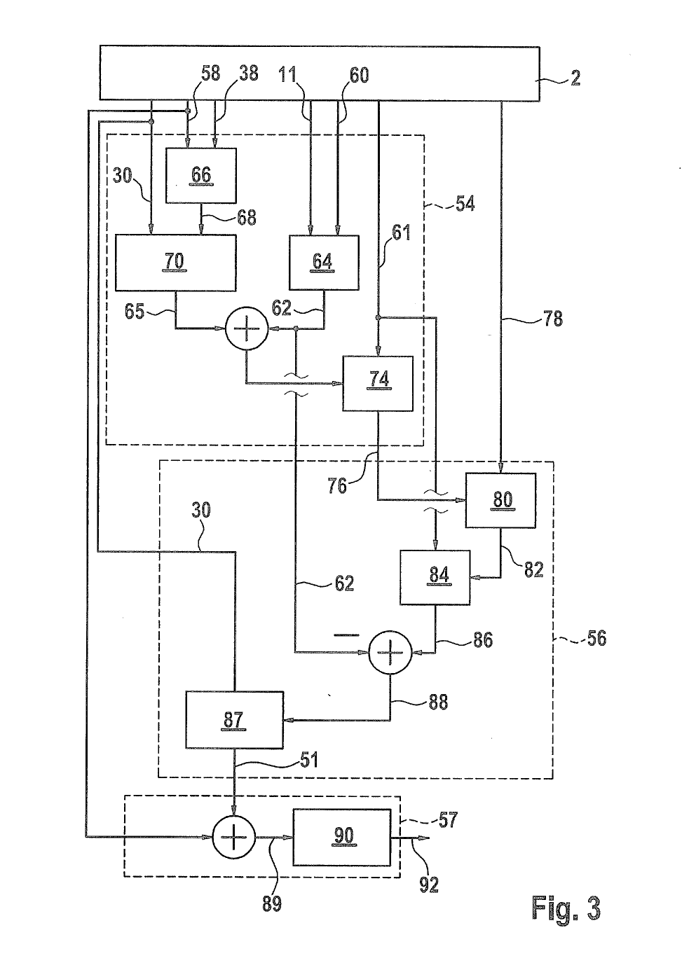

In equation (1), λₐ is volumetric efficiency 58 shown in FIG. 3 and it indicates the ratio of the real volume flow in the engine to the ideal (theoretically possible) volume flow in the engine. V_{H} is the swept volume of internal combustion engine 4. n is rotational speed 38 of internal combustion engine 4. p is pressure 30 in intake manifold 16 measured by pressure sensor 24. R is the general gas constant. T is temperature 28, which is measured by temperature sensor 26 or modeled, in intake manifold 16 in the flow direction downstream from junction 17 of recirculated exhaust gas 18.

To measure volumetric efficiency 58, exhaust gas recirculation 18 may, for example, be interrupted during a calibration measurement and the filling may be determined. The measured value for volumetric efficiency 58 is determinable by solving equation (1) according to volumetric efficiency 58.

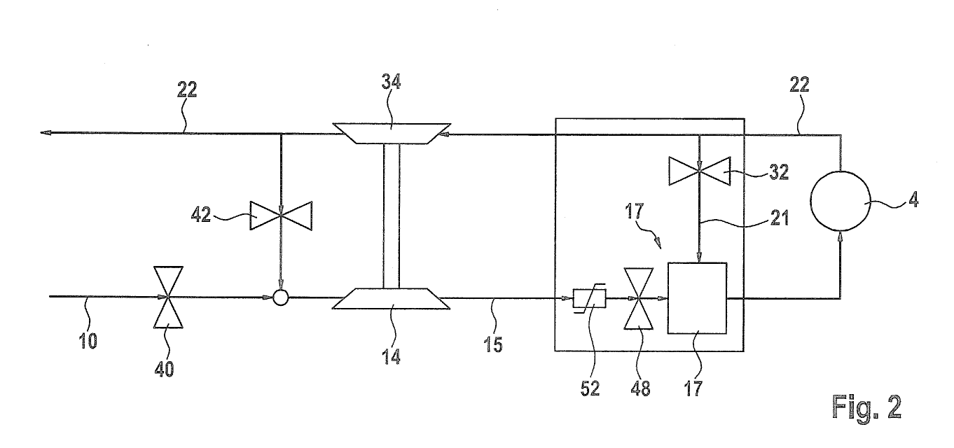

Measured volumetric efficiency 58 is checked for plausibility according to the present invention. For this purpose, it may, for example, be estimated one more time and checked based on that. This type of estimation and check is explained based on FIGS. 2 and 3, as an example, where elements identical to FIG. 1 are provided with identical reference numerals and are not described again.

In FIG. 2, one or multiple compressor(s) 14 separate(s) the air supply in the engine into a low-pressure area and a high-pressure area. In the low-pressure area, fresh air 10 taken in is guided via a low-pressure valve 40 (not shown in FIG. 1) and mixed with a portion of exhaust gas 22 downstream from turbine 34. The quantity of exhaust gas 22 to be added in the low-pressure area is controlled via a low-pressure exhaust gas recirculation valve 42. In the high-pressure area, the supply of compressed fresh air 15 to junction 17 is controlled via a throttle valve 48 (not shown in FIG. 1).

FIG. 3 shows the structure diagram of the determination of the plausibility check of measured volumetric efficiency 58 based on estimated volumetric efficiency 51. To determine estimated volumetric efficiency 51, the sequence shown in FIG. 3 includes a balancing section 54 and an estimation section 56. After the estimation, measured volumetric efficiency 58 is checked in a checking section 57 based on the estimation.

In the present embodiment, the estimation of volumetric efficiency 58 is based on the mass flow of recirculated exhaust gas 21, since this variable is redundantly determinable in most vehicles so that the value for the mass flow of recirculated exhaust gas 21, which has the greatest information content, may always be used for the estimation. If, for example, valve 32 in exhaust gas recirculation channel 18 is closed, but one of the values for the mass flow of recirculated exhaust gas 21 is greater than zero, its information content is equal to zero, since the value is obviously incorrect.

In balancing section 54, a value 76 is determined for the mass flow of recirculated exhaust gas 21 as the estimation basis for estimation section 56. This essentially takes place based on a balancing of the filling and fresh air mass flow 11. For implementability reasons, not the mass flows themselves, but the enthalpy flows associated with them, are balanced, however. To carry out the calculations, pressure 30, measured volumetric efficiency 58, rotational speed 38, and fresh air mass flow 11 are supplied to balancing section 56 from engine system 2. From a temperature sensor 26 (shown in FIG. 1), temperature 60 of compressed fresh air 15 prevails in balancing section 54 upstream from throttle valve 48, which is assigned symbol T_{vD}. Temperature 61, which is assigned symbol T_{A}, is detected in the same manner in exhaust gas recirculation channel 18 and made available to balancing section 54. As an alternative to the measurement, the temperatures may also be modeled upstream from throttle valve 48 and in exhaust gas recirculation channel 18.

The determination of enthalpy flow 62 through throttle valve 48 takes place in balancing section 54 based on a first function 64 having functional derivative f₁, which is assigned symbol \dot{h}_{L}. In f₁, fresh air mass flow 11 and temperature 60 of compressed fresh air 15 upstream from throttle valve 48 are incorporated according to the following equation:

\dot{h}_{L}=f₁(\dot{m}_{L},T_{vD}) (2)

Functional derivative f₁ of first function 64 may be derived from a thermodynamic approach to enthalpy flow determination.

To determine enthalpy flow 65 through internal combustion engine 4, volume flow 38 through internal combustion engine 4 must initially be determined, which is assigned symbol \dot{V}_{F}. This takes place in a second function 66 having functional derivative f₂ based on measured volumetric efficiency 58 and rotational speed 38 according to the following equation:

\dot{v}_{F}=f₂(λₐ,n) (3)

Functional derivative f₂ of second function 66 may be derived from a volume balance in the engine and may be stored in a memory of engine control 13, for example. Enthalpy flow 65 through internal combustion engine 4, which is assigned symbol \dot{h}_{F}, is then yielded in balancing section 54 using a third function 70 having functional derivative f₃ based on previously calculated volume flow 68 and pressure 30 in internal combustion engine 4 according to the following equation:

\dot{h}_{F}=f₃(p,\dot{v}_{F}) (4)

Functional derivative f₃ of third function 70 may be derived from a thermodynamic approach to enthalpy flow determination.

To balance enthalpy flow 72 through valve 32 in exhaust gas recirculation channel 18 having symbol \dot{h}_{A,Balance}, it is assumed in one variant that neither mass nor enthalpy may be stored in junction 17. Balanced enthalpy flow 72 is then yielded according to the following equation:

\dot{h}_{A,Bilanz}=\dot{h}_{L}−\dot{h}_{F} (5)

### [Bilanz=Balance]

This equation may be further expanded by memory effects of the mixing location as well as wall heating processes.

Subsequently, balanced enthalpy flow 72 is converted using a fourth function 74 having functional derivative f₁ based on temperature 61 in exhaust gas recirculation channel 18 into first value 76 for the mass flow of recirculated exhaust gas 21, which is assigned symbol \dot{m}_{A,Balance}, according to the following equation:

\dot{h}_{A,Bilanz}=f₁(\dot{m}_{A,Bilanz},T_{A}) (6)

### [Bilanz=Balance]

In estimation section 56, an estimation of the actual mass flow of recirculated exhaust gas 21 is carried out based on this first value 76 for the mass flow of recirculated exhaust gas 21 and a second value 78 for mass flow \dot{m}_{A} of recirculated exhaust gas 21, which is assigned symbol \dot{m}_{A,Valve}. Second value 78 may, for example, be determined directly from a measurement of pressure ratio at exhaust gas recirculation valve 32 using a thermodynamic approach, for example, with the aid of a throttle equation.

Ideally, first value 76 and second value 78 for the mass flow of recirculated exhaust gas 21 are identical. In practice, however, the two values always deviate slightly from one another. In the previously mentioned manner, that value 76, 78 is selected for determination of estimated volumetric efficiency 51 in estimation section 56 whose information content is greater due to certain boundary conditions. This selection takes place via an estimation function 80 in estimation section 56, a Kalman filter, for example.

From estimated mass flow 82 of recirculated exhaust gas 21, output by estimation function 80, an estimated enthalpy flow 86 through exhaust gas recirculation channel 18 may be calculated together with temperature 61 in exhaust gas recirculation channel 18 in a fifth function 84, which is based on functional derivative f₁ of equation (2). By balancing this estimated enthalpy flow 86 of recirculated exhaust gas 21 and enthalpy flow 62 through throttle valve 48 output from first function 64, an estimated enthalpy flow 88 through internal combustion engine 4 is determined in estimation section 56, based on which estimated volumetric efficiency 51 is finally calculated via pressure 30 in a sixth function 87, which is based on functional derivatives f₂, f₃.

In monitoring section 57, measured volumetric efficiency 58 is checked for plausibility by a comparison based on estimated volumetric efficiency 51. The comparison takes place by the formation of a difference 89 which is checked for its level in a filter 90. If measured volumetric efficiency 58 deviates too excessively from estimated volumetric efficiency 51, an error 92 is finally output by monitoring section 57.

According to the present invention, the volumetric efficiency is used for error diagnosis in a vehicle, since it is calculated anyway within the scope of the control systems present in the vehicle, thus allowing not only for a diagnosis at smaller measurement complexity but also providing the diagnosis results on a time constant of the control which uses the volumetric efficiency.

What is claimed is:

1. A device for error monitoring in an engine system having an internal combustion engine, the engine system being configured to supply the internal combustion engine with air at a volumetric efficiency indicating the ratio of actual volume flow of air in the internal combustion engine to an ideal, theoretically possible, volume flow of air in the internal combustion engine, the device comprising:
a detection system for at least one of measuring and estimating the volumetric efficiency; and
an error-monitoring unit configured to determine an error in the engine system based on the at least one of the measured volumetric efficiency and the estimated volumetric efficiency.

2. The device as recited in claim 1, wherein:
the detection system includes a measuring device configured to measure the volumetric efficiency and an estimation device configured to estimate the volumetric efficiency; and
the error-monitoring unit includes a checking device configured to check the measured volumetric efficiency for plausibility based on the estimated volumetric efficiency.

3. The device as recited in claim 2, wherein the device is a vehicle diagnostic system for a vehicle driven by the internal combustion engine.

4. The device as recited in claim 2, wherein the checking device is configured to: (i) calculate a difference between the measured volumetric efficiency and the estimated volumetric efficiency; and (ii) output an error signal when the difference exceeds a predetermined absolute value.

5. An engine system for driving a vehicle, comprising:
an internal combustion engine configured to receive a charge of fresh air for a fuel combustion and to output exhaust gas after the fuel combustion, wherein the internal combustion engine is supplied with the fresh air at a volumetric efficiency indicating the ratio of actual volume flow of air in the internal combustion engine to an ideal, theoretically possible, volume flow of air in the internal combustion engine; and
an error-monitoring system including: (i) a measuring device configured to measure the volumetric efficiency and an estimation device configured to estimate the volumetric efficiency; and (ii) a checking device configured to output an error signal when a difference between the measured volumetric efficiency and the estimated volumetric efficiency exceeds a predetermined absolute value.

6. The engine system as recited in claim 5, further comprising:
at least one intake system configured to take in fresh air into the engine system;
at least one exhaust gas recirculation system configured to recirculate at least a portion of the exhaust gas into the internal combustion engine; and
at least one mixing unit configured to mix the fresh air and the recirculated exhaust gas.

7. The engine system as recited in claim 6, wherein a device for modeling the volumetric efficiency based on the pressure of the mixture of the fresh air and the recirculated exhaust gas, the temperature of the mixture of the fresh air and the recirculated exhaust gas, and the rotational speed of the internal combustion engine is provided.

8. The engine system as recited in claim 6, wherein the volumetric efficiency is estimated based on an enthalpy flow balance between the enthalpy flow of the fresh air and the enthalpy flow of the recirculated exhaust gas.

9. The engine system as recited in claim 8, wherein the enthalpy flow of the recirculated exhaust gas is estimated based on a mass flow of the recirculated exhaust gas through the exhaust gas recirculation system.

10. The engine system as recited in claim 8, wherein the enthalpy flow of the recirculated exhaust gas is estimated based on a mass flow of the recirculated exhaust gas through the mixing unit.

11. A method for error monitoring in an engine system having an internal combustion engine, the engine system being configured to supply the internal combustion engine with air at a volumetric efficiency indicating the ratio of actual volume flow of air in the internal combustion engine to an ideal, theoretically possible, volume flow of air in the internal combustion engine, the method comprising:
measuring the volumetric efficiency;
estimating the volumetric efficiency; and
checking the measured volumetric efficiency for plausibility based on the estimated volumetric efficiency, wherein an error is detected when a difference between the measured volumetric efficiency and the estimated volumetric efficiency exceeds a predetermined absolute value.
